(19) United States
(12) Patent Application Publication
(10) Pub. No.: US 2012/0144670 A1
(43) Pub. Date: Jun. 14, 2012

(54) METHOD FOR MANUFACTURING POWER SOCKET

(75) Inventors: Ying-Sung Ho, Taoyuan City (TW); Ta-Feng Yeh, Taoyuan City (TW); Yu-Chieh Wang, Taoyuan City (TW)

(73) Assignee: SOLTEAM ELECTRONICS CO., LTD., Taoyuan (TW)

(21) Appl. No.: 12/965,970

(22) Filed: Dec. 13, 2010

(51) Int. Cl. H01R 43/20

(52) U.S. Cl. 29/876

(57) ABSTRACT

A method for manufacturing a power socket is disclosed as that the power socket has at least two metal pins and an insulating seat member, wherein one end of each of the integrally-formed metal pin is defined as a solid round-column shaped contact section and the other end thereof is defined as a flat terminal section, the terminal section and the contact section are integrally formed in one piece.

### BACKGROUND OF THE INVENTION

1. Field of the Invention

The present invention generally relates to a method for manufacturing a power socket, more particularly to a method for manufacturing a power socket that has at least two metal pins and an insulating seat member, wherein one end of each of the integrally-formed metal pins is defined as a solid round-column shaped contact section and the other end thereof is defined as a flat terminal section, the terminal section and the contact section are integrally formed in one piece.

2. Description of the Prior Art

Power sockets are commonly used in electronic goods, e.g. a portable audio player or a DVD player, or in information products such as a computer, a power wire whose two ends are both sockets is used and the two ends are respectively plugged into a power socket of a product and a socket of public electricity, so the power is provided to the product and a user can therefore operate the product.

The must have units in an assembly of a power socket is at least two metal pins, conventional metal pins can be categorized to two sorts, hollow and solid; a hollow metal pin is made by punching a metal sheet, e.g. a copper sheet, for obtaining a sheet member having a pre-determined shape, then one end of the sheet member is rolled so as to be defined as a round-column shaped contact section, the other end thereof is integrally contact section and the terminal section are made as one piece, instead of being connected via rivets. The disadvantage of the hollow metal pin is that the hollow metal pin is made via a rolling formation, so the strength of the hollow metal pin is not strong enough and is easily to be deformed. Regarding to the disadvantages mentioned above, the applicant of the present invention has disclosed a solution, such as Taiwan Patent No. M292812, titled “Power supply connector”, the above mentioned patent disclosed that, in a power socket, an insulating column (a jointing section) of a seat member is received in accommodating spaces respectively formed inside each contact section of each hollow metal pin, so the strength of the pins and the structural stress are increased. With the raising costs of the metal sheets, the formation of the hollow metal pins result in an issue of wasting materials, and the manufacturing cost is therefore increased. In fact, serious disadvantages of both of a hollow metal pin and a hollow metal pin provided in an insulating column are that the thickness is not enough so the voltage endurance and the current endurance are obviously not enough and can not pass the safety regulation.

For overcoming the above mentioned disadvantages of a hollow metal pin, skilled people in the art has disclosed a power socket having a solid metal pin, as shown in FIG. 1, a seat member 10 of the power socket is provided with a solid contact pin 20 and a terminal 30, the solid contact pin 20 and the terminal 30 are riveted and embedded in the insulating seat member 10, such connecting means has to consider the riveting strength. Beside, for manufacturing the solid contact pin, operation procedures of cutting and riveting are increased and result in a higher production cost for preventing the solid contact pin 20 from loosing, a blocking ring 201 having a larger outer diameter is radially provided to the solid contact pin 20, and the outer diameter of the blocking ring 201 is the original outer diameter of the solid metal round-column shaped member; the solid contact pin 20 and the blocking ring 201 are made via cutting the original solid metal round-column shaped member, and the amount of the cut-off material is about 40% thus the production cost is hard to be reduced. More over, if the riveting strength between the solid contact pin 20 and the terminal 30 is not strong enough, or when an external force is strong enough to cause a loosing effect on the riveting position between the solid contact pin 20 and the terminal 30, sparks or loose may be generated due to the high temperature or the poor combination, and this will greatly affect the safe operation and shall be improved.

Hence, to develop a method for manufacturing an advanced power socket is the most important issue for the skilled persons in the art.

### SUMMARY OF THE INVENTION

The main objective of the present invention is to provide a method for manufacturing a power socket in order to manufacture the power socket that has: at least two metal pins, one end of each of the integrally-formed metal pins being defined as a solid round-column shaped contact section and the other end thereof being defined as a flat terminal section, the terminal section and the contact section being integrally formed in one piece, instead of being connected via riveting which may loose and cause dangers; and an insulating seat member. Hence an anticipated structural strength is also achieved, and the safety use is ensured and the service life of the power socket is prolonged.

The second objective of the present invention is to provide the method for manufacturing the power socket so as to achieve that the metal pin manufactured by the manufacturing method provided by the present invention has the advantages of saving materials, fast in formation, and the automatic punching formation mold adopted by the present invention increasing the production rate.

The method for manufacturing a power socket, wherein the power socket has at least two solid metal pins and an insulating seat member, comprises the steps of:
(1) disposing a solid round-column shaped metal wire A1 into an automatic punching formation mold B by means of a feeding machine B1 and two material-guiding seats B2, the metal wire A1 being punched by two punching blocks B3 located at the two lateral sides with respect to the metal wire A1, so that the front and rear ends of a period, defined as a solid metal pin 1′, of the metal wire A1 are respectively provided with an arc-shaped cutting mark A2 according to a requested length L of the solid metal pin 1′, please refer to FIG. 10A and FIG. 11;
(2) the solid metal pin 1′ of the metal wire A1, which length L is predefined by the two punching blocks B3, being moved forwardly on the automatic punching formation mold B, the arc-shaped cutting marks A2 of the front and rear ends of the solid metal pin 1′ being punched by a head-section punching block (not shown in figure) above the metal wire A1, so two arc-shaped head sections A3 are obtained, wherein the solid metal pin 1′ with the arc-shaped head sections A3 is not separated from the other solid metal pin 1′ while the arc-shaped head section A3 of a round-column shaped contact section 11A′ is processed precisely, please refer to FIG. 10B;
(3) the other end opposite to the end with the round-column shaped contact section 11A′ of the solid metal pin 1′ being punched by a terminal-section punching block B4 and then being laterally extended from the other end, so a flat terminal section 12A′ is obtained, wherein the contact section 11A′ and the terminal section 12A′ are formed in one piece, instead of connection via riveting, please refer to FIG. 10C;
(4) the solid metal pin 1′ having the contact section 11A′ and the terminal section 12A′ being moved to a flange-punching block B5 (not shown in figure), part of the two lateral sides of the terminal section 12A′ being cut off by the punch of the flange-punching black B5, and part of the two lateral sides of the contact section 11A′ being cut off as well, so that a flange 16A′ is formed at each of the two lateral sides of the terminal section 12A′ and a concave section 14A′ (not shown in FIG. 11) is formed at each of the two lateral sides of the contact section 11A′ in order to enhance the connecting effect with an insulating seat member, please refer to FIG. 10D;
(5) the terminal section 12A′ being moved to a processing punching block B6 for machining so as to form an accommodating section 15A′ as a through hole or concave slot, which is to store a welding material while a welding operation is processed so as to enhance the connecting strength between the terminal section 12A′ and an object as a printed circuit board, please refer to FIG. 10E;
(6) the solid metal pin 1′ having the contact section 11A′ and the terminal section 12A′ being conveyed to the rear end of the automatic punching formation mold B, the terminal section 12A′ being disposed to contact with a position-limiting block B7, and cutting off the connecting head section 11B′ of the contact section 11A′ by means of a cutting punching block (not shown in figure), so the contact section 11A′ is separated from the terminal section 12A′ of the other solid metal pin 1′ behind, please refer to FIG. 10F;
(7) the terminal section 12A′ of the solid metal pin 1′ being moved further and thus bent by a bending punching block B8 so as to form an included angle between the contact section 11A′ and the terminal section 12A′, so an L-shaped solid metal pin is obtained, please refer to FIG. 10G; and
(8) firmly disposing the two solid metal pins into a mold (not shown in figure), which is to shape the insulating seat member, injecting melted plastic materials into the mold by way of an embedded-type plastic molding formation, the certain portions, such as the lower portions of the contact sections 11A′ and the front portions of the terminal sections 12A′, of the solid metal pins 1′ being positioned and retained as well, so each of the contact sections 11A′ is accommodated and positioned in a connecting hole (not shown in figure) disposed on the surface of the seat member and the rear portions of the two terminal sections 12A′ are exposed outside of the other surface of the seat member.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 is a cross sectional view of a conventional power socket;

FIG. 2 is a 3D-view of a metal pin used in the power socket of a method for manufacturing a power socket of the present invention;

FIG. 3 is a cross sectional view of the power socket having the metal pin shown in FIG. 2 of the method for manufacturing the power socket of the present invention;

FIG. 4 is a 3D-view of the power socket shown in FIG. 3 of the method for manufacturing the power socket of the present invention;

FIG. 5 is a 3D-view of another metal pin of the method for manufacturing the power socket of the present invention;

FIG. 6 is a cross sectional view of the power socket having the metal pin shown in FIG. 5 of the method for manufacturing the power socket of the present invention;

FIG. 7 is a 3D-view of another metal pin of the method for manufacturing the power socket of the present invention;

FIG. 8 is a cross sectional view of the power socket having the metal pin shown in FIG. 7 of the method for manufacturing the power socket of the present invention;

FIG. 9 illustrates a flow chart of the first preferred embodiment of the method for manufacturing the power socket of the present invention;

FIG. 10A-10G illustrate serial schematic views of the first preferred embodiment of the method for manufacturing the power socket of the present invention; and

FIG. 11 illustrates a schematic view of a serial work station of the first preferred embodiment of manufacturing a single solid metal pin of the power socket of the present invention.

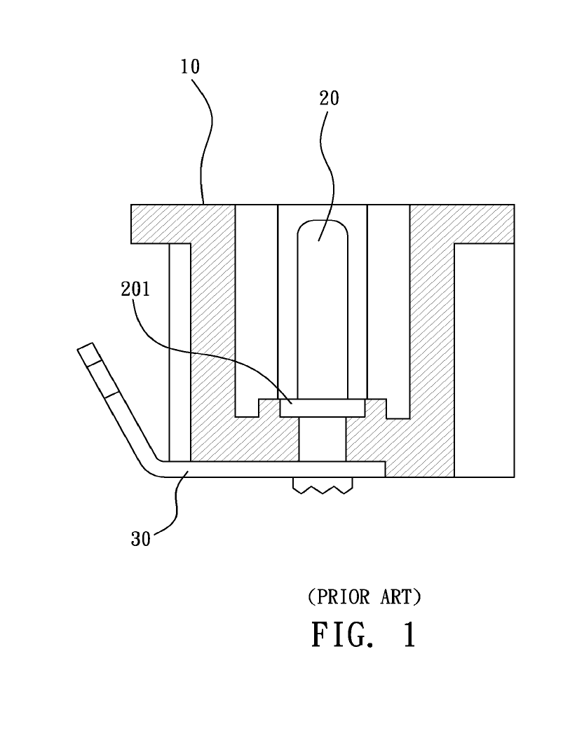

### DETAILED DESCRIPTION OF THE INVENTION

Following preferred embodiments and figures will be described in detail so as to achieve aforesaid objects.

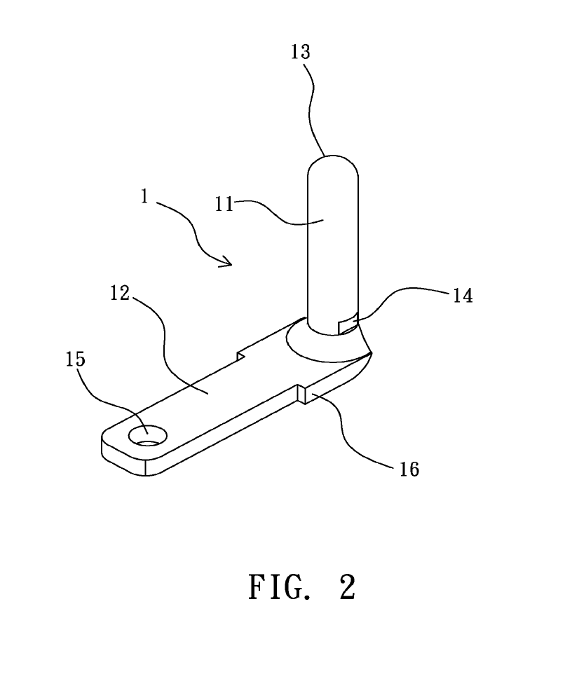

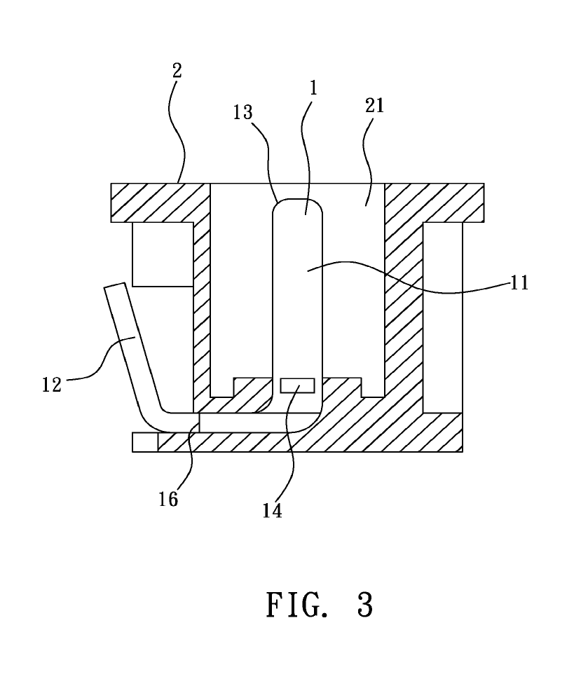

As shown from FIG. 2 to FIG. 4, which are a 3D-view of a first preferred embodiment of a metal pin used in a power socket of the method for manufacturing the power socket of the present invention, a cross sectional view of the power socket having the metal pin shown in FIG. 2 of the method for manufacturing the power socket of the present invention and a 3D-view of the power socket shown in FIG. 3 of the method for manufacturing the power socket of the present invention. The power socket provided by the present invention is composed by at least two metal pins 1 and an insulating seat member 2.

Each of the metal pins 1 is integrally formed by punching and bending a solid round-column shaped metal wire, so one end of each of the metal pins 1 is defined as a solid round-column shaped contact section 11, the other end thereof is defined as a flat terminal section 12. Each of the contact sections 11 and each of the terminal sections 12 are both punched and bent therefore an included angle, e.g. a 90-degree included angle, is formed between each of the contact sections 11 and the corresponding terminal section 12, so the metal pin 1 is shaped to an L-shape as shown in FIG. 2. For providing a better connecting relationship between the power socket and the contact section 11, the top end of the contact section 11 is provided with an arc-shaped head section 13, and for having a better connecting relationship between the contact section 11 and the seat member 2, at least one concave section 14 is provided at the bottom end of the contact section 11, so when an accommodating section 15 is formed on the terminal section 12 and when the terminal section 12 is bent, the concave section 14 can be served to retain the contact section 11 for preventing the contact section 11 from rotating.

The terminal section 12 has at least one accommodating section 15, e.g. a through hole or a concave slot, for being operated with a welding operation. For providing a better connecting relationship between the terminal section 12 and the seat member 2, a flange 16 is respectively extended from two lateral sides of the terminal section 12, so when the terminal section 12 is covered by plastic materials, the solidified plastic materials can be served as blocks for blocking the pair of flanges 16, so the metal pin 1 can be stably retained in the seat member 2.

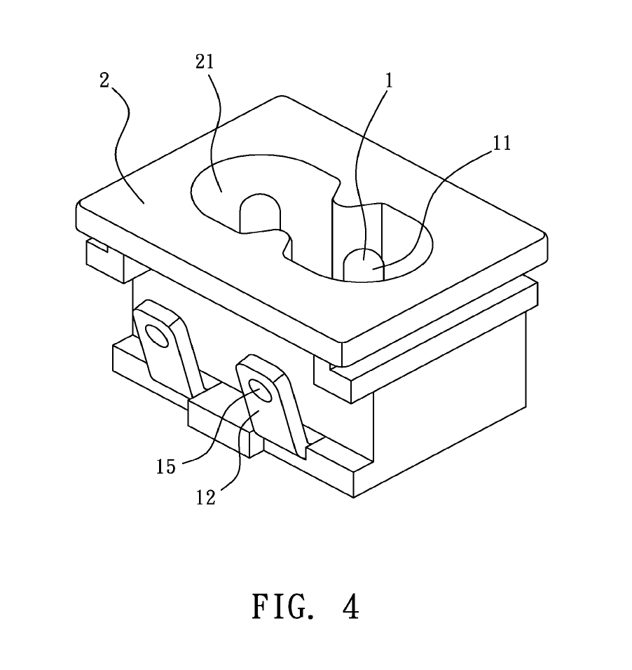

The seat member 2 is a solid member made via a plastic injecting formation, to manufacture a power socket, at least two metal pins 1 are stably provided in a mold for forming the seat member 2, high-temperature liquid plastic materials are poured into the mold via an embedded-type plastic injecting formation, so when the seat member 2 is formed, the certain portions of the metal pins 1, e.g. the lower portions of the contact sections 11 and the front portions of the terminal sections 12, are also positioned and retained, so each of the contact sections 11 is accommodated and positioned in a connecting hole 21 provided on a surface of the seat member 2, and the rear portions of the two terminal sections 12 are exposed outside of the other surface of the seat member 2, then the power socket provided by the present invention is manufactured. The terminal sections 12 can be operated with a punching operation according to actual needs, so the terminal sections 12 respectively have a bending angle, as shown in FIG. 3 and FIG. 4.

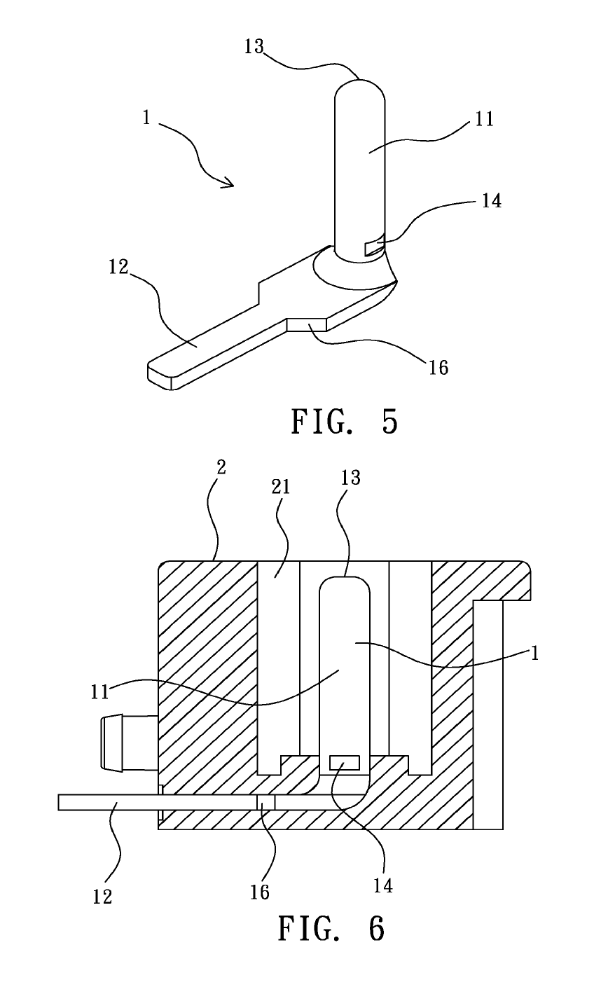

As shown in FIG. 5, which is a 3D-view of a second preferred embodiment of the metal pin of the method for manufacturing the power socket of the present invention, the difference between this structure and the previous structure is that there is no accommodating section provided and the width of the terminal section 12 is narrower. Referring to FIG. 6, which is a cross sectional view of the power socket having the metal pin shown in FIG. 5 of the method for manufacturing the power socket of the present invention and what is shown is that after the metal pin 1 shown in FIG. 5 is being operated with an injecting formation with the insulating seat member 2, the terminal section 12 is straightly and transversally extended from the lateral wall of the seat member 2, and no bending operation is processed, so the terminal section 12 can be directly mounted on a printed circuit board.

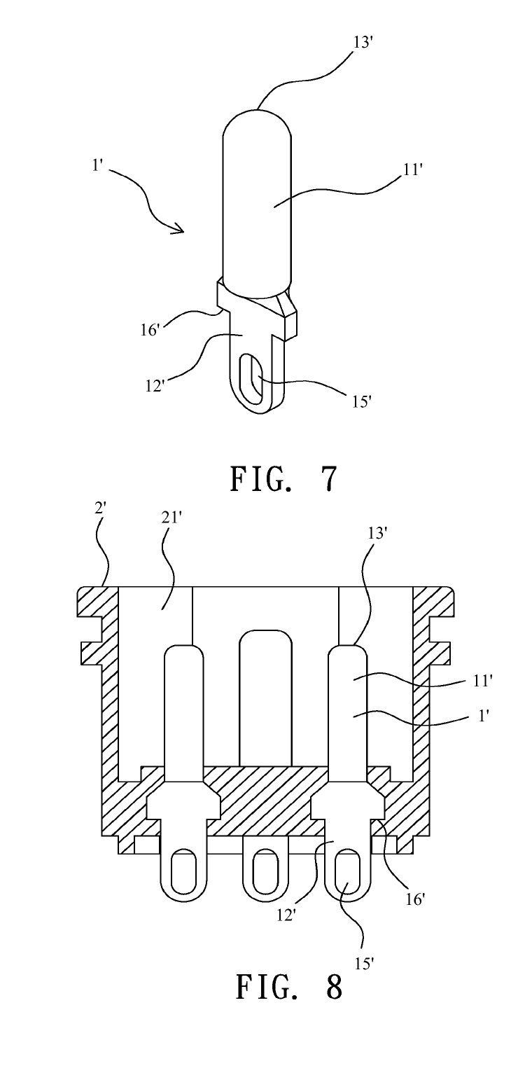

As shown in FIG. 7, which is a 3D-view of a third preferred embodiment of the metal pin of the method for manufacturing the power socket of the present invention. The difference between this structure and the previous two structures is the contact section 11′ and the terminal section 12′ are straightly provided and there is no included angle generated. Referring to FIG. 8, which is a cross sectional view of the power socket having the metal pin shown in FIG. 7 of the method for manufacturing the power socket of the present invention and what is shown is that after the metal pin 1′ shown in FIG. 7 is being operated with an injecting formation with the insulating seat member 2′, the terminal section 12′ is straightly and longitudinally extended from the bottom end of the seat member 2′. The metal pin 1′ of the power socket provided by the present invention is formed by punching a solid round-column shaped metal wire, e.g. a copper wire, so one end of the metal wire is defined as a solid round-column-shaped contact section 11′ having advantages of good strength, voltage endurance and current endurance and is qualified to pass the safety regulation; the other end is defined as a terminal section 12′ which is integrally extended bent from the contact section 11′, instead of being jointed via riveting, so the loose or the release resulted from the poor riveting is prevented, the safety use is therefore ensured, and the service life of the power socket is prolonged.

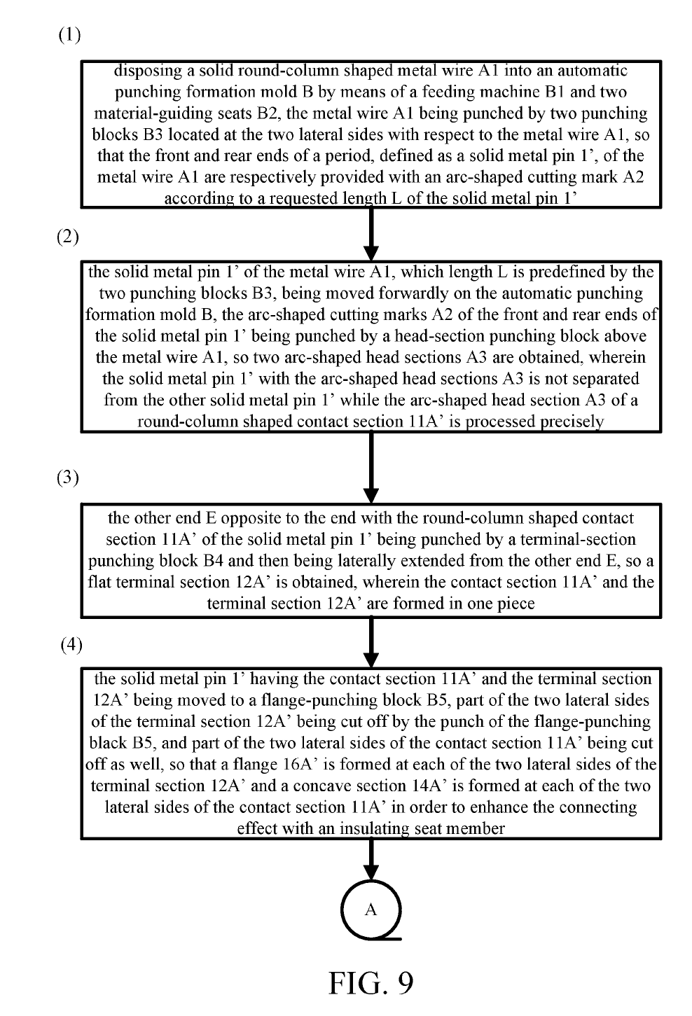

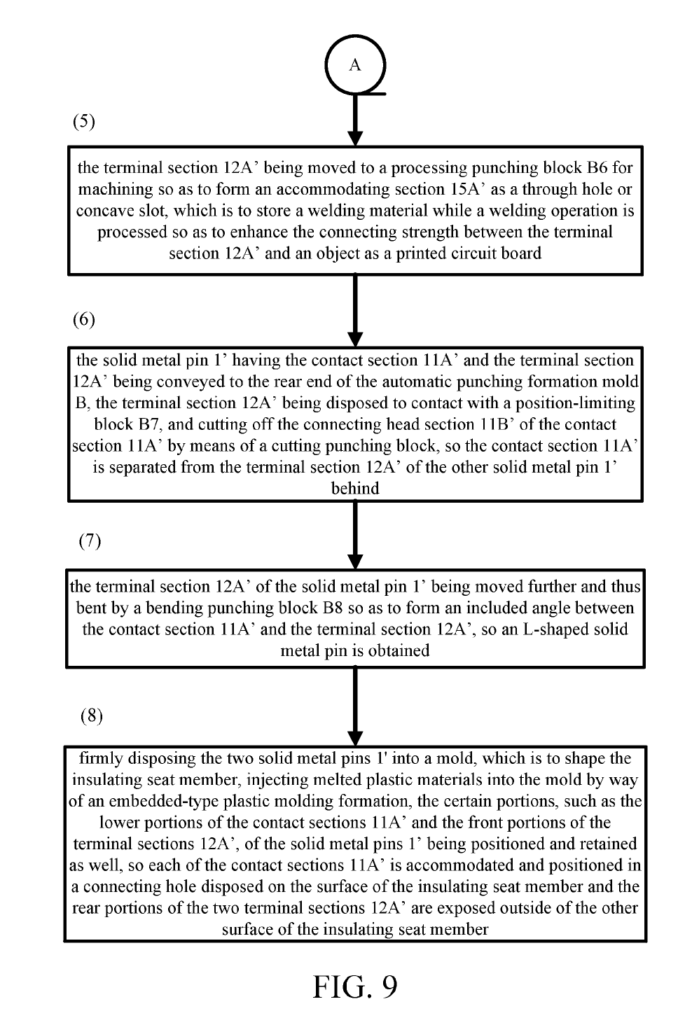

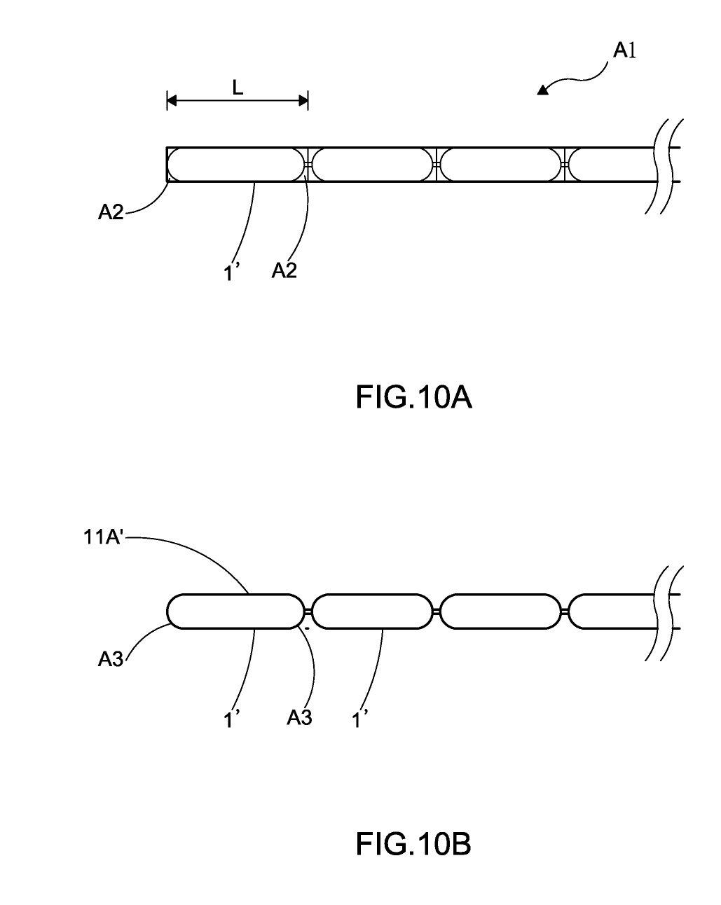

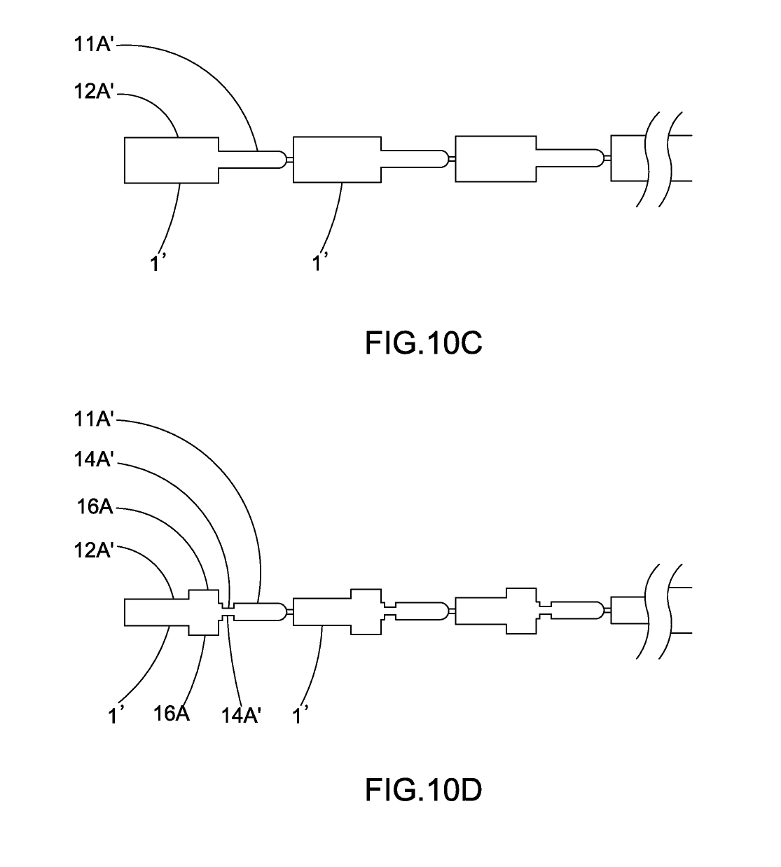

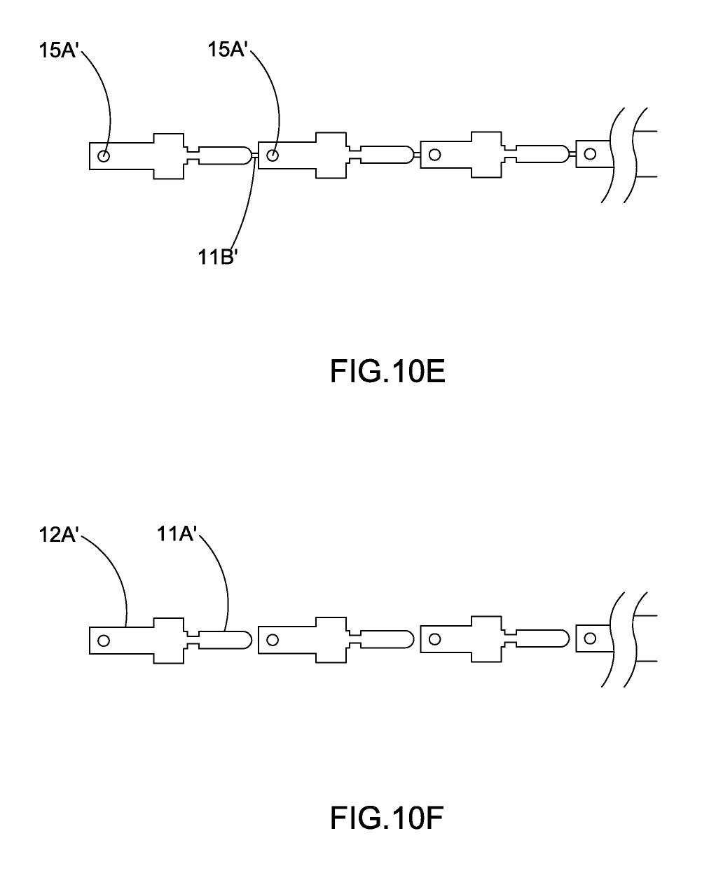

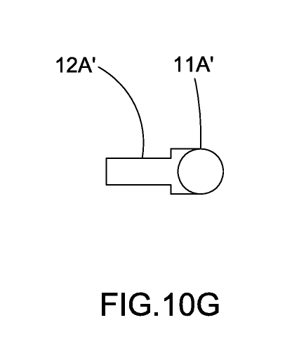

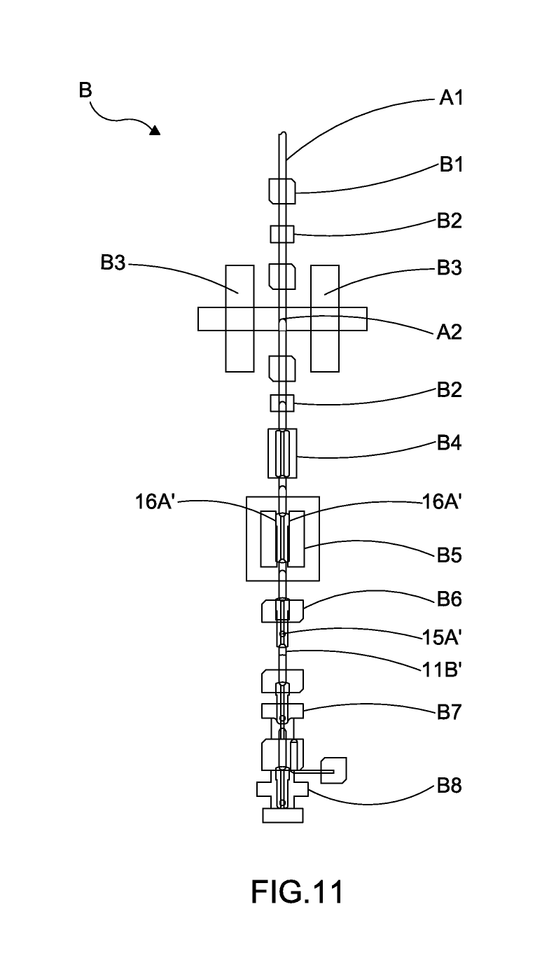

Referring to FIG. 9, FIG. 10A-10G and FIG. 11, which illustrate a flow chart of the first preferred embodiment of the metal pin of the method for manufacturing the power socket of the present invention, serial schematic views of the first preferred embodiment of the method for manufacturing the power socket of the present invention and a schematic view of a serial work station of the first preferred embodiment of manufacturing a single solid metal pin of the power socket of the present invention. The power socket has at least two solid metal pins and an insulating seat member, comprising the steps of:
(1) disposing a solid round-column shaped metal wire A1 into an automatic punching formation mold B by means of a feeding machine B1 and two material-guiding seats B2, the metal wire A1 being punched by two punching blocks B3 located at the two lateral sides with respect to the metal wire A1, so that the front and rear ends of a period, defined as a solid metal pin 1′, of the metal wire A1 are respectively provided with an arc-shaped cutting mark A2 according to a requested length L of the solid metal pin 1′, please refer to FIG. 10A and FIG. 11;
(2) the solid metal pin 1′ of the metal wire A1, which length L is predefined by the two punching blocks B3, being moved forwardly on the automatic punching formation mold B, the arc-shaped cutting marks A2 of the front and rear ends of the solid metal pin 1′ being punched by a head-section punching block (not shown in figure) above the metal wire A1, so two arc-shaped head sections A3 are obtained, wherein the solid metal pin 1′ with the arc-shaped head sections A3 is not separated from the other solid metal pin 1′ while the arc-shaped head section A3 of a round-column shaped contact section 11A′ is processed precisely, please refer to FIG. 10B;
(3) the other end E opposite to the end with the round-column shaped contact section 11A′ of the solid metal pin 1′ being punched by a terminal-section punching block B4 and then being laterally extended from the other end E, so a flat terminal section 12A′ is obtained, wherein the contact section 11A′ and the terminal section 12A′ are formed in one piece, instead of connection via riveting, please refer to FIG. 10C;
(4) the solid metal pin 1′ having the contact section 11A′ and the terminal section 12A′ being moved to a flange-punching block B5 (not shown in figure), part of the two lateral sides of the terminal section 12A′ being cut off by the punch of the flange-punching black B5, and part of the two lateral sides of the contact section 11A′ being cut off as well, so that a flange 16A′ is formed at each of the two lateral sides of the terminal section 12A′ and a concave section 14A′ (not shown in FIG. 11) is formed at each of the two lateral sides of the contact section 11A′ in order to enhance the connecting effect with an insulating seat member, please refer to FIG. 10D;
(5) the terminal section 12A′ being moved to a processing punching block B6 for machining so as to form an accommodating section 15A′ as a through hole or concave slot, which is to store a welding material while a welding operation is processed so as to enhance the connecting strength between the terminal section 12A′ and an object as a printed circuit board, please refer to FIG. 10E;
(6) the solid metal pin 1′ having the contact section 11A′ and the terminal section 12A′ being conveyed to the rear end of the automatic punching formation mold B, the terminal section 12A′ being disposed to contact with a position-limiting block B7, and cutting off the connecting head section 11B′ of the contact section 11A′ by means of a cutting punching block (not shown in figure), so the contact section 11A′ is separated from the terminal section 12A′ of the other solid metal pin 1′ behind, please refer to FIG. 10F;
(7) the terminal section 12A′ of the solid metal pin 1′ being moved further and thus bent by a bending punching block B8 so as to form an included angle between the contact section 11A′ and the terminal section 12A′, so an L-shaped solid metal pin is obtained, please refer to FIG. 10G; and
(8) firmly disposing the two solid metal pins 1′ into a mold (not shown in figure), which is to shape the insulating seat member, injecting melted plastic materials into the mold by way of an embedded-type plastic molding formation, the certain portions, such as the lower portions of the contact sections 11A′ and the front portions of the terminal sections 12A′, of the solid metal pins 1′ being positioned and retained as well, so each of the contact sections 11A′ is accommodated and positioned in a connecting hole (not shown in figure) disposed on the surface of the insulating seat member and the rear portions of the two terminal sections 12A′ are exposed outside of the other surface of the insulating seat member.

Preferably, due to that the second preferred embodiment of the metal pin is short of the accommodating section 15 as shown in the first preferred embodiment of FIG. 2, the flow chart of the second preferred embodiment of the metal pin of the method for manufacturing the power socket of the present invention may be lack of step (5) as aforesaid for the first preferred embodiment.

Preferably, due to that the third preferred embodiment of the metal pin is not bent as shown in the first preferred embodiment of FIG. 2, the flow chart of the third preferred embodiment of the metal pin of the method for manufacturing the power socket of the present invention may be lack of step (7) as aforesaid for the first preferred embodiment.

Further, a fourth preferred embodiment of the metal pin is short of the accommodating section 15′ as shown in the third preferred embodiment of FIG. 7, the flow chart of the fourth preferred embodiment of the metal pin of the method for manufacturing the power socket of the present invention may be lack of step (5) and step (7) as aforesaid for the first preferred embodiment.

In the manufacturing method mentioned above, a solid round-column shaped metal wire is processed with the steps of multi-punching, one end of the integrally-formed metal pin is defined as a solid round-column shaped contact section, and the other end thereof is defined as a flat terminal section, and an anticipated structural strength is also achieved, and the terminal section and the contact section are integrally formed in one piece, instead of being connected via riveting which may loose and cause dangers, therefore the safety use is ensured and the service life of the power socket is prolonged. Comparing to a metal pin made by conventional means of cutting and riveting, the metal pin manufactured by the manufacturing method provided by the present invention has advantages of saving materials, fast in formation, and the automatic punching formation mold adopted by the present invention increases the production rate.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A method for manufacturing a power socket, wherein the power socket has at least two solid metal pins and an insulating seat member, comprising the steps of:
(1) disposing a solid round-column shaped metal wire into an automatic punching formation mold by means of a feeding machine and two material-guiding seats, the metal wire being punched by two punching blocks located at the two lateral sides with respect to the metal wire, so that the front and rear ends of a period, defined as the solid metal pin, of the metal wire are respectively provided with an arc-shaped cutting mark according to a requested length of the solid metal pin;
(2) the solid metal pin 1′ of the metal wire, which length is predefined by the two punching blocks, being moved forwardly on the automatic punching formation mold, the arc-shaped cutting marks of the front and rear ends of the solid metal pin being punched by a head-section punching block above the metal wire, so two arc-shaped head sections are obtained, wherein the solid metal pin with the arc-shaped head sections is not separated from the other solid metal pin while the arc-shaped head section of a round-column shaped contact section is processed precisely;
(3) the other end opposite to the end with the round-column shaped contact section of the solid metal pin being punched by a terminal-section punching block and then being laterally extended from the other end, so a flat terminal section is obtained, wherein the contact section and the terminal section are formed in one piece, instead of connection via riveting;
(4) the solid metal pin having the contact section and the terminal section being moved to a flange-punching block, part of the two lateral sides of the terminal section being cut off by the punch of the flange-punching black, and part of the two lateral sides of the contact section 11A′ being cut off as well, so that a flange is formed at each of the two lateral sides of the terminal section and a concave section is formed at each of the two lateral sides of the contact section in order to enhance the connecting effect with the insulating seat member;
(5) the terminal section being moved to a processing punching block for machining so as to form an accommodating section, which is to store a welding material while a welding operation is processed so as to enhance the connecting strength between the terminal section and an welded object;
(6) the solid metal pin having the contact section and the terminal section being conveyed to the rear end of the automatic punching formation mold, the terminal section being disposed to contact with a position-limiting block, and cutting off the connecting head section of the contact section by means of a cutting punching block, so the contact section is separated from the terminal section of the other solid metal pin behind;
(7) the terminal section of the solid metal pin being moved further and thus bent by a bending punching block so as to form an included angle between the contact section and the terminal section, so an L-shaped solid metal pin is obtained; and
(8) firmly disposing the two solid metal pins into a mold, which is to shape the insulating seat member, injecting melted plastic materials into the mold by way of an embedded-type plastic molding formation, the certain portions of the solid metal pins being positioned and retained as well, so each of the contact sections is accommodated and positioned in a connecting hole disposed on the surface of the seat member and the rear portions of the two terminal sections are exposed outside of the other surface of the seat member.

2. The method for manufacturing the power socket according to claim 1, wherein the accommodating section of step (5) is a through hole.

3. The method for manufacturing the power socket according to claim 1, wherein the accommodating section of step (5) is a concave slot.

4. The method for manufacturing the power socket according to claim 1, wherein the welded object of step (5) is a printed circuit board.

5. The method for manufacturing the power socket according to claim 1, wherein the certain portion of the solid metal pins of step (8) is the lower portions of the contact sections.

6. The method for manufacturing the power socket according to claim 1, wherein the certain portion of the solid metal pins of step (8) is the front portions of the terminal sections.

7. A method for manufacturing a power socket, wherein the power socket has at least two solid metal pins and an insulating seat member, comprising the steps of:
(1) disposing a solid round-column shaped metal wire into an automatic punching formation mold by means of a feeding machine and two material-guiding seats, the metal wire being punched by two punching blocks located at the two lateral sides with respect to the metal wire, so that the front and rear ends of a period, defined as the solid metal pin, of the metal wire are respectively provided with an arc-shaped cutting mark according to a requested length of the solid metal pin;
(2) the solid metal pin 1′ of the metal wire, which length is predefined by the two punching blocks, being moved forwardly on the automatic punching formation mold, the arc-shaped cutting marks of the front and rear ends of the solid metal pin being punched by a head-section punching block above the metal wire, so two arc-shaped head sections are obtained, wherein the solid metal pin with the arc-shaped head sections is not separated from the other solid metal pin while the arc-shaped head section of a round-column shaped contact section is processed precisely;
(3) the other end opposite to the end with the round-column shaped contact section of the solid metal pin being punched by a terminal-section punching block and then being laterally extended from the other end, so a flat terminal section is obtained, wherein the contact section and the terminal section are formed in one piece, instead of connection via riveting;
(4) the solid metal pin having the contact section and the terminal section being moved to a flange-punching block, part of the two lateral sides of the terminal section being cut off by the punch of the flange-punching black, and part of the two lateral sides of the contact section 11A′ being cut off as well, so that a flange is formed at each of the two lateral sides of the terminal section and a concave section is formed at each of the two lateral sides of the contact section in order to enhance the connecting effect with the insulating seat member;
(5) the solid metal pin having the contact section and the terminal section being conveyed to the rear end of the automatic punching formation mold, the terminal section being disposed to contact with a position-limiting block, and cutting off the connecting head section of the contact section by means of a cutting punching block, so the contact section is separated from the terminal section of the other solid metal pin behind;
(6) the terminal section of the solid metal pin being moved further and thus bent by a bending punching block so as to form an included angle between the contact section and the terminal section, so an L-shaped solid metal pin is obtained; and
(7) firmly disposing the two solid metal pins into a mold, which is to shape the insulating seat member, injecting melted plastic materials into the mold by way of an embedded-type plastic molding formation, the certain portions of the solid metal pins being positioned and retained as well, so each of the contact sections is accommodated and positioned in a connecting hole disposed on the surface of the seat member and the rear portions of the two terminal sections are exposed outside of the other surface of the seat member.

8. The method for manufacturing the power socket according to claim 7, wherein the certain portion of the solid metal pins of step (7) is the lower portions of the contact sections.

9. The method for manufacturing the power socket according to claim 7, wherein the certain portion of the solid metal pins of step (7) is the front portions of the terminal sections.

10. A method for manufacturing a power socket, wherein the power socket has at least two solid metal pins and an insulating seat member, comprising the steps of:
(1) disposing a solid round-column shaped metal wire into an automatic punching formation mold by means of a feeding machine and two material-guiding seats, the metal wire being punched by two punching blocks located at the two lateral sides with respect to the metal wire, so that the front and rear ends of a period, defined as the solid metal pin, of the metal wire are respectively provided with an arc-shaped cutting mark according to a requested length of the solid metal pin;
(2) the solid metal pin 1′ of the metal wire, which length is predefined by the two punching blocks, being moved forwardly on the automatic punching formation mold, the arc-shaped cutting marks of the front and rear ends of the solid metal pin being punched by a head-section punching block above the metal wire, so two arc-shaped head sections are obtained, wherein the solid metal pin with the arc-shaped head sections is not separated from the other solid metal pin while the arc-shaped head section of a round-column shaped contact section is processed precisely;
(3) the other end opposite to the end with the round-column shaped contact section of the solid metal pin being punched by a terminal-section punching block and then being laterally extended from the other end, so a flat terminal section is obtained, wherein the contact section and the terminal section are formed in one piece, instead of connection via riveting;
(4) the solid metal pin having the contact section and the terminal section being moved to a flange-punching block, part of the two lateral sides of the terminal section being cut off by the punch of the flange-punching black, and part of the two lateral sides of the contact section 11A′ being cut off as well, so that a flange is formed at each of the two lateral sides of the terminal section and a concave section is formed at each of the two lateral sides of the contact section in order to enhance the connecting effect with the insulating seat member;
(5) the terminal section being moved to a processing punching block for machining so as to form an accommodating section, which is to store a welding material while a welding operation is processed so as to enhance the connecting strength between the terminal section and an welded object;
(6) the solid metal pin having the contact section and the terminal section being conveyed to the rear end of the automatic punching formation mold, the terminal section being disposed to contact with a position-limiting block, and cutting off the connecting head section of the contact section by means of a cutting punching block, so the contact section is separated from the terminal section of the other solid metal pin behind; and
(7) firmly disposing the two solid metal pins into a mold, which is to shape the insulating seat member, injecting melted plastic materials into the mold by way of an embedded-type plastic molding formation, the certain portions of the solid metal pins being positioned and retained as well, so each of the contact sections is accommodated and positioned in a connecting hole disposed on the surface of the seat member and the rear portions of the two terminal sections are exposed outside of the other surface of the seat member.

11. The method for manufacturing the power socket according to claim 10, wherein the accommodating section of step (5) is a through hole.

12. The method for manufacturing the power socket according to claim 10, wherein the accommodating section of step (5) is a concave slot.

13. The method for manufacturing the power socket according to claim 10, wherein the welded object of step (5) is a printed circuit board.

14. The method for manufacturing the power socket according to claim 10, wherein the certain portion of the solid metal pins of step (7) is the lower portions of the contact sections.

15. The method for manufacturing the power socket according to claim 10, wherein the certain portion of the solid metal pins of step (7) is the front portions of the terminal sections.

16. A method for manufacturing a power socket, wherein the power socket has at least two solid metal pins and an insulating seat member, comprising the steps of:
(1) disposing a solid round-column shaped metal wire into an automatic punching formation mold by means of a feeding machine and two material-guiding seats, the metal wire being punched by two punching blocks located at the two lateral sides with respect to the metal wire, so that the front and rear ends of a period, defined as the solid metal pin, of the metal wire are respectively provided with an arc-shaped cutting mark according to a requested length of the solid metal pin;
(2) the solid metal pin 1′ of the metal wire, which length is predefined by the two punching blocks, being moved forwardly on the automatic punching formation mold, the arc-shaped cutting marks of the front and rear ends of the solid metal pin being punched by a head-section punching block above the metal wire, so two arc-shaped head sections are obtained, wherein the solid metal pin with the arc-shaped head sections is not separated from the other solid metal pin while the arc-shaped head section of a round-column shaped contact section is processed precisely;
(3) the other end opposite to the end with the round-column shaped contact section of the solid metal pin being punched by a terminal-section punching block and then being laterally extended from the other end, so a flat terminal section is obtained, wherein the contact section and the terminal section are formed in one piece, instead of connection via riveting;
(4) the solid metal pin having the contact section and the terminal section being moved to a flange-punching block, part of the two lateral sides of the terminal section being cut off by the punch of the flange-punching black, and part of the two lateral sides of the contact section 11A′ being cut off as well, so that a flange is formed at each of the two lateral sides of the terminal section and a concave section is formed at each of the two lateral sides of the contact section in order to enhance the connecting effect with the insulating seat member;
(5) the solid metal pin having the contact section and the terminal section being conveyed to the rear end of the automatic punching formation mold, the terminal section being disposed to contact with a position-limiting block, and cutting off the connecting head section of the contact section by means of a cutting punching block, so the contact section is separated from the terminal section of the other solid metal pin behind; and
(6) firmly disposing the two solid metal pins into a mold, which is to shape the insulating seat member, injecting melted plastic materials into the mold by way of an embedded-type plastic molding formation, the certain portions of the solid metal pins being positioned and retained as well, so each of the contact sections is accommodated and positioned in a connecting hole disposed on the surface of the seat member and the rear portions of the two terminal sections are exposed outside of the other surface of the seat member.

17. The method for manufacturing the power socket according to claim 1, wherein the certain portion of the solid metal pins of step (6) is the lower portions of the contact sections.

18. The method for manufacturing the power socket according to claim 1, wherein the certain portion of the solid metal pins of step (6) is the front portions of the terminal sections.
